(19) United States
(12) Patent Application Publication
(10) Pub. No.: US 2018/0075533 A1
(43) Pub. Date: Mar. 15, 2018

(54) PREDICTION OF BINARY OUTCOME

(71) Applicant: SPOT OPTION LTD, RAMAT GAN (IL)

(72) Inventor: AMNON GOLDRAT, TEL AVIV (IL)

(21) Appl. No.: 15/563,823

(22) PCT Filed: Mar. 31, 2016
(86) PCT No.: PCT/IL2016/050344

§ 371 Date: Oct. 2, 2017

(30) Foreign Application Priority Data
Apr. 2, 2015 (IL) 238133

(51) Int. Cl. G06Q 40/06; G06Q 40/04; G06F 3/048; G09B 19/18; G09B 5/12

(52) U.S. Cl. CPC G06Q 40/06; G06Q 40/04; G09B 5/125; G09B 19/18; G06F 3/048

(57) ABSTRACT

System, device, and method for checking a prediction of non-random binary outcome are provided. The system comprises a processing server, with a connection to external feed provider having real-time data on the non-random binary outcome and a user terminal connected to the processing server, the connection allowing sending and receiving information, wherein the user terminal is also configured to allow sending input parameters to the processing server. The processing server has a dedicated binary prediction algorithm configured to allow comparison between the input parameters and data received from the external feed provider, and wherein the input parameters correspond to prediction of the non-random binary increased or decreased outcome. The device comprises a graphical user interface (GUI), a wireless service connection, and a processor with dedicated binary prediction algorithm.

### FIELD OF THE INVENTION

The present invention relates to binary options. More particularly, the present invention relates to methods for prediction of binary outcome, and also relates to dedicated devices for carrying out automated training with binary options.

### BACKGROUND OF THE INVENTION

Banks and other financial investment firms have been operating with “binary options” (also known as digital options, all-or-nothing options, or fixed return options) since the early 20th century. Binary options predict how the price of a stock, commodity, index, or pair of currency exchange, will change by a designated expiration date.

A binary option allows a potential user to predict if a selected asset price goes up or down, according to a predetermined entry point as the execution and expiry time of that asset. The users (or “traders”) do not purchase or own the asset, as they only predict which in direction the asset changes. Namely, there are only two possible outcomes (up or down) and the actual asset price does not matter.

If the prediction was correct, then the trade is accomplished and considered “in the money” so that the trader receives the fixed return on the investment. Otherwise, if the prediction was incorrect, then the trade is considered “out of the money” and the trader loses the amount agreed upon in the binary option.

As customary in various fields, including finance, with training users gain experience and improves their skills. Binary options correspond to actual financial values, as opposed to means for predictions that have a random factor, such as the lottery or certain sport events. It would therefore be advantageous to have a way of training with binary options, as it's independent of random factors.

### SUMMARY OF THE INVENTION

According to a first aspect of the invention, a system for checking a prediction of non-random binary outcome is provided, comprising:

a processing server, with a connection to at least one external feed provider having real-time data on the non-random binary outcome; and

a user terminal connected to the processing server, the connection allowing sending and receiving information, wherein the user terminal is also configured to allow sending input parameters to the processing server,

wherein the processing server has a dedicated binary prediction algorithm configured to allow comparison between the input parameters and data received from the at least one external feed provider, and wherein the input parameters correspond to prediction of the non-random binary increased or decreased outcome.

In some embodiments, the input parameters correspond to initial information received from the at least one external feed provider.

In some embodiments, the user terminal has a wireless service connection configured to allow receiving information from the at least one feed provider.

In some embodiments, the user terminal further has a graphical user interface (GUI) configured to allow interaction with the user to enter the input parameters.

In some embodiments, the user terminal further has a scanner capable of identifying markings on a physical card, and wherein the markings correspond to prediction of the non-random binary outcome.

In some embodiments, the user terminal further has a printer capable of printing output corresponding to the input parameters.

In some embodiments, the user terminal further has a card reader capable of identifying information from smart cards.

In some embodiments, the user terminal is selected from a group including: dedicated portable devices, dedicated training machines, pre-existing devices with a dedicated training algorithm.

In some embodiments, the comparison is carried out at a predetermined expiry period.

According to a second aspect of the invention, a device for checking a prediction of non-random binary outcome is provided, comprising:

a graphical user interface (GUI) configured to allow interaction with the user;

a wireless service connection, configured to allow receiving information from at least one feed provider having real-time data on the non-random binary outcome; and

a processor with a dedicated binary prediction algorithm, configured to allow comparison between a prediction for the non-random binary increased or decreased outcome and data received from the at least one external feed provider.

In some embodiments, the device further comprises a scanner capable of identifying markings on a physical card, wherein the markings correspond to the prediction of the non-random binary outcome.

In some embodiments, the device further comprises a printer capable of printing output corresponding to the prediction of the non-random binary outcome.

In some embodiments, the device further comprises a card reader capable of identifying information from smart cards.

In some embodiments, the comparison is carried out at a predetermined expiry period.

According to a third aspect of the invention, a method for checking a prediction of non-random binary outcome is provided, comprising:

displaying at least one asset;

choosing an expiry period;

selecting at least one asset from the displayed assets;

marking an increased value or a decreased value, for each of the selected at least one asset;

receiving real-time data from at least one feed provider at the end of the expiry period, wherein the data comprises information on change in value for the selected at least one asset;

comparing the received data with a predicted outcome form the marking; and

providing physical confirmation if at least one marking matches the received data.

In some embodiments, the method further comprises providing physical output, and wherein the output corresponds to the selections and markings.

In some embodiments, the method further comprises choosing a multiple expiry period, and wherein receiving real-time data and comparison to markings restarts for each chosen multiple expiry periods.

In some embodiments, the markings are carried out on a physical card, and wherein the method further comprises reading the markings from the physical card.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary training board, according to an exemplary embodiment.

FIG. 2 shows a block diagram of a method for training with binary options, according to an exemplary embodiment.

FIG. 3 shows a training system, according to an exemplary embodiment.

FIG. 4A shows a printed ticket prior to selections made by the user, according to an exemplary embodiment.

FIG. 4B shows a printed output ticket with information on the selections of the user, according to an exemplary embodiment.

FIG. 4C shows a printed confirmation output for a correct prediction, according to an exemplary embodiment.

FIG. 4D shows a printed confirmation output for an incorrect prediction, according to an exemplary embodiment.

FIG. 4E shows a printed report for previous actions, according to an exemplary embodiment.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For clarity, non-essential elements were omitted from some of the drawings.

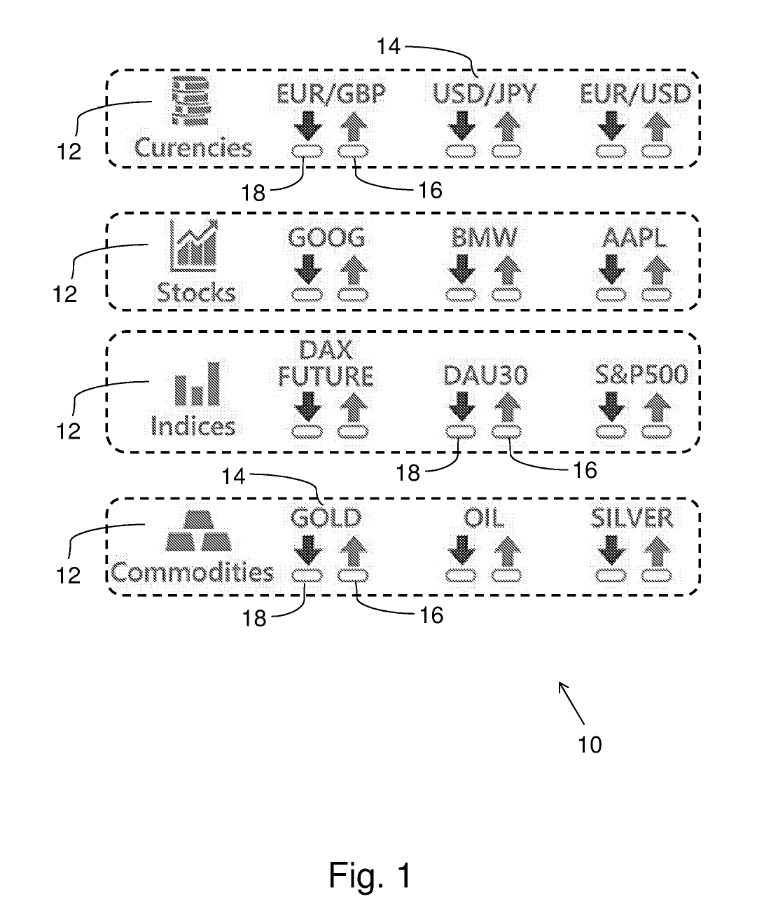

FIG. 1 shows an exemplary training board 10. It is appreciated that such training boards may be manifested in various forms (virtual and physical). For example, the exemplary training board 10 may be displayed in dedicated software on a computer screen, or alternatively displayed on a physical printed ticket. Optionally, the printed ticket may be marked with choices and then read by a machine for further processing. Additional forms of training and also usage of the training board are further described hereinafter.

The exemplary training board 10 comprises multiple asset types 12, whereby each asset type 12 further comprises at least one underlying asset 14 (e.g. the Silver commodity). A user interested in training for binary options, for instance in order to improve the skill of understanding financial market trends, may use a training system (with dedicated software, servers, machines etc.) and select a particular asset 14 as a binary option.

The user may then choose if the value of the selected asset 14, increases 16 or alternatively decreases 18 until a predetermined expiry time. During the training, users may compare their choices with actual values in the real world, for example real binary option values from common feed providers such as “Reuters”.

The asset types 12 typically include at least one of the following:
Currencies—a pair of currency exchange rate. For example, Euros vs. U.S. Dollars, wherein such pairing may be marked in abbreviated form as EUR/USD. The currency on the left (EURO in this example) is typically referred to as the “base currency”, with a value set to 1. The currency on the right (USD in this example) is typically referred to as the “counted currency”.
Stocks—a single stock of major international companies. For example, GM, BP, Google (e.g. abbreviated as “GOOG”), Apple, BMW, Tesco. etc.
Indices—each index asset represents a price or rate of a group of stocks traded in a single stock exchange market. For example, “Nasdaq Future” represents the index of the hundred largest domestic and international non-financial companies registered on Wall-Street (the premier US stock exchange in New York).
Commodities—major international commodity indexes, such as: Gold, Silver, Oil, Sugar, Coffee, Wheat, and Platinum. Commodity trading is based on a price unit (in any type of currency, and typically in US dollars) of each asset, e.g. an oil barrel, a gold ounce, etc.

It should be noted that the number of asset types 12 may be predetermined by the user, as well as the number of assets 14 in each selected asset type 12. Furthermore, the asset types 12 may additionally include any other financial asset type as a basis for creating a binary option.

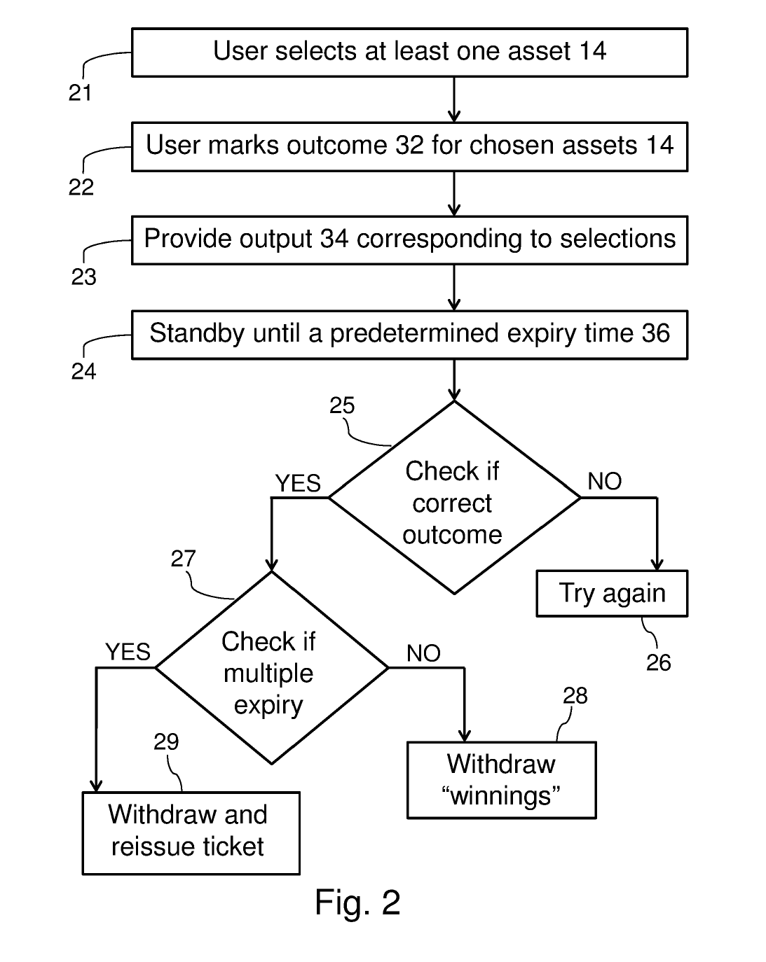

FIG. 2 shows a block diagram of a method for training with binary options. Initially, a user selects 21 at least one asset 14 (for instance from a training board, as shown in FIG. 1). Next, the user marks 22 the outcome 32 of the previously selected at least one asset 14. Namely, for each of the at least one asset 14, the user marks whether the value of the selected asset increases or alternatively decreases until a predetermined expiry time. This selection of the expected values for each of the at least one asset 14, is considered as the expected outcome 32 of the training.

It should be noted that the selections 21, 22 by the user, may be carried out with physical means, such as dedicated mobile devices or printed tickets. In case of a printed ticket, the user may mark the desirable assets and outcome on the ticket to be later read by a user training terminal. Alternatively, the selections 21, 22 by the user, may be carried out with virtual means, using dedicated software for such training. The physical and virtual means are further described in greater detail hereinafter.

Following the selections 21, 22 by the user, the training system may provide a physical output 34 to the user, whereby the output 34 corresponds to the selections of the user. The output 34 may be for instance a printed ticket with markings of the selections 21, 22 by the user. The output 34 includes information on at least one of the following:
A time stamp for the selections 21, 22.
The selected outcome 32, corresponding to the selected assets 14.
A unique identification number for the selections, in order to differentiate from other selections (e.g. by other users).
The entry rate, i.e. the value of the chosen underlying asset 14 at the time of the marking 22, based on real-time market conditions.

At this stage, the system is in standby mode 24, until a predetermined expiry time 36 is detected by the system. The expiry time 36 may be determined by the user during marking 22 of the outcome 32. Optionally, the expiry time 36 may be very long and occur at a different date. Once the expiry time 36 is detected by the system, the chosen binary option expires.

After the binary option expires, the training system may check whether the outcome 32 is correct 25. Namely, the systems checks if the values of the selected 21 assets 14 increased or decreased by receiving real financial information from feed providers (e.g. “Reuters”). The system then compares the real result at the time of expiry as the “expiry rate”, with the predicted outcome 32 that was previously chosen 22 by the user. It should be noted that a different expiry rate is determined for each of the chosen assets 14.

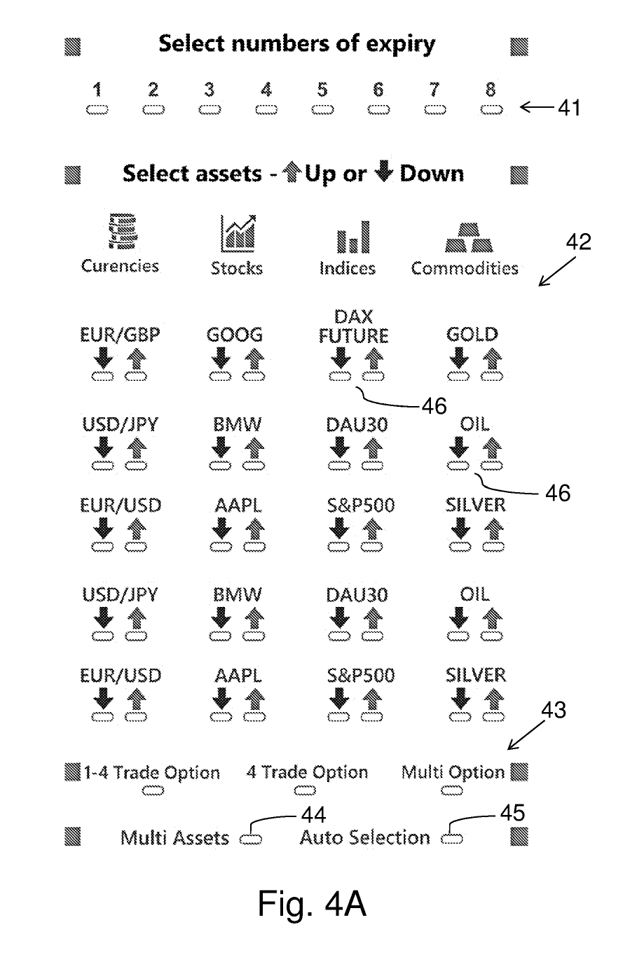

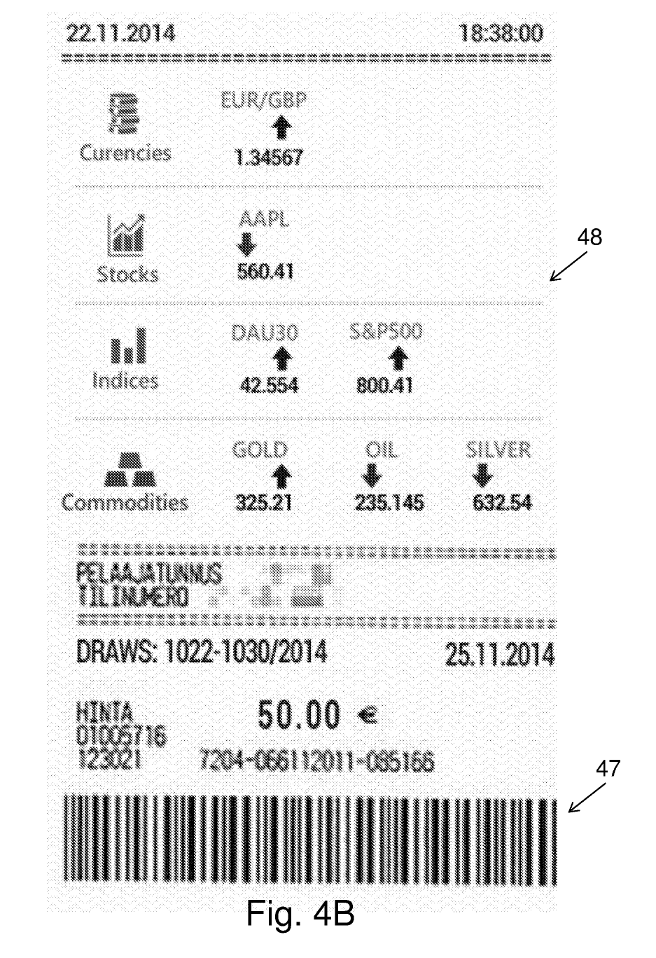

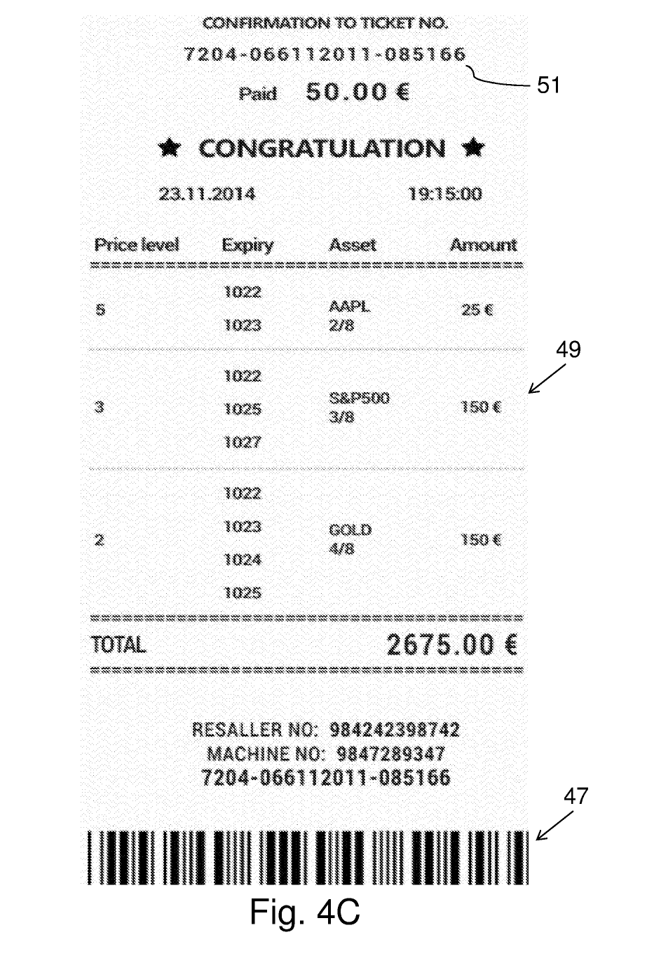

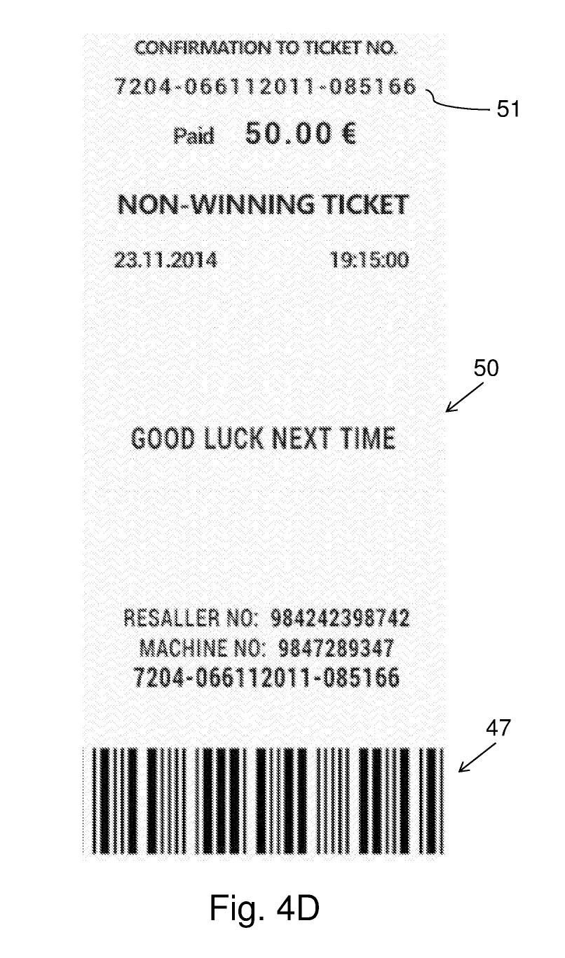

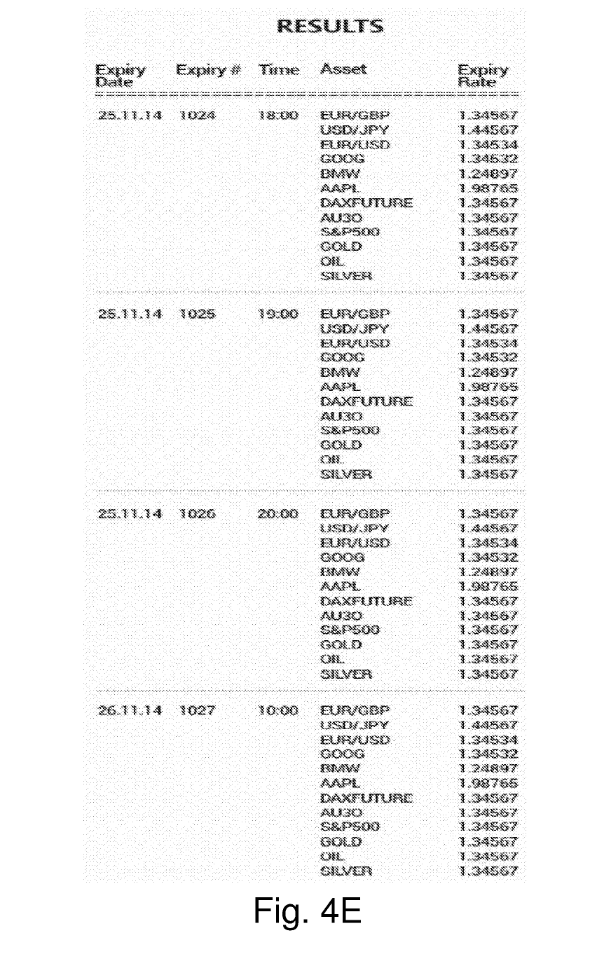

In some embodiments, it may be possible to get a detailed report of all past selections for a particular user. If every output 34 includes a unique identification number, then it may be possible to provide a detailed report for a user, the report including all past selections and their corresponding results. Thus, this report creates an easy way of monitoring the training process. Such a report may be available to the user via the abovementioned physical or virtual means. An exemplary report is shown in FIG. 4E.

In case that the chosen outcome 32 is incorrect (after comparison to real results from the feed providers), the user may be prompted to try again 26 and make new selections for the same (or other) assets. Optionally, a confirmation ticket may be printed for the user. An exemplary confirmation ticket is shown in FIG. 4D.

It is appreciated that if the real results from the feed providers indicate that the value of the option did not change, then the user may also be prompted to try again 26 and make new selections for the same (or other) assets. Since binary options require choosing whether the value increases or decreases, the possibility of an unchanged value should also be covered by the training process. In a further embodiment, the user may choose an outcome where the value of the option is unchanged.

In case the chosen outcome 32 is correct (after comparison to real results from the feed providers), the system checks 27 if the initial selections 21, 22 included a “multiple expiry”. A multiple expiry selection comprises multiple sequential expiry periods, such that an intermediate outcome occurs every time a period expires. In case that the initial selections 21, 22 did not include a “multiple expiry”, then the user may simply withdraw 28 the “winnings” for the chosen option. The winnings may include a virtual amount of some currency to be used in the future for further training. For example, winning 200 virtual gold coins to be later distributed in several assets during future training sessions.

In some embodiments, the abovementioned process may be carried out with real currency (e.g. similarly to some slot machines, while the outcome has no random factors), wherein the final winnings may be increased based on an initial amount provided by the user. It should be noted that the real currency may be provided by the user with physical means (as in a slot machine), or with virtual means (as in online betting games). For example, the user initially provides an investment of ten US dollars and chooses assets 14, with a predicted outcome 32 corresponding to the selections by the user and also to the investment provided by the user. Thus, if the predicted outcome is correct then the winnings collected by the user are increased by the investment. If for example, the chosen option expires at the same value as the entry rate (i.e. the value did not increase or decrease) then the investment is fully returned to the user.

In case that the initial selections 21, 22 include a “multiple expiry”, then the user may withdraw the “winnings” for the chosen option and also reissue 29 the same outcome 32 for additional expiry periods, whereby the reissue is carried out prior to the final expiry time. It is appreciated that after an expiry period, the user does not change the predicted outcome 32, but actually only decides whether to proceed with the outcome 32 for an additional expiry period.

Optionally, some assets 14 are chosen with multiple expiry periods, while other assets 14 may be chosen with a single expiry period. It should be noted that the user may continuously review the progress of the selection, and individually choose for each asset 14 whether to proceed to an additional expiry period. For example, a user selects 22 several assets 14 with a particular outcome, whereby the user additionally chooses a tripled expiry period. If the predicted outcome 32 is correct after the first period expires, then the user may choose to proceed with an additional expiry period, wherein the entry rate for the second expiry period is automatically the expiry rate that was determined at the end of the first expiry period.

In some embodiments, the abovementioned method may be implemented as a game instead of as training method. While the abovementioned training method is aimed for improvement in a skill for the financial domain, it may also be utilized for entertainment or games, whereby the skill to be improved is the game skill. Thus, the same method may be carried out as a game, where the object of the user is to predict the correct outcome (based on real-time data from financial markets). Similarly for instance to a Lottery game, wherein a user predicts an outcome based on random factors and then with time improves the game skill (due to learning of statistical rules of randomization), in contrast to the abovementioned method where no random factors occur.

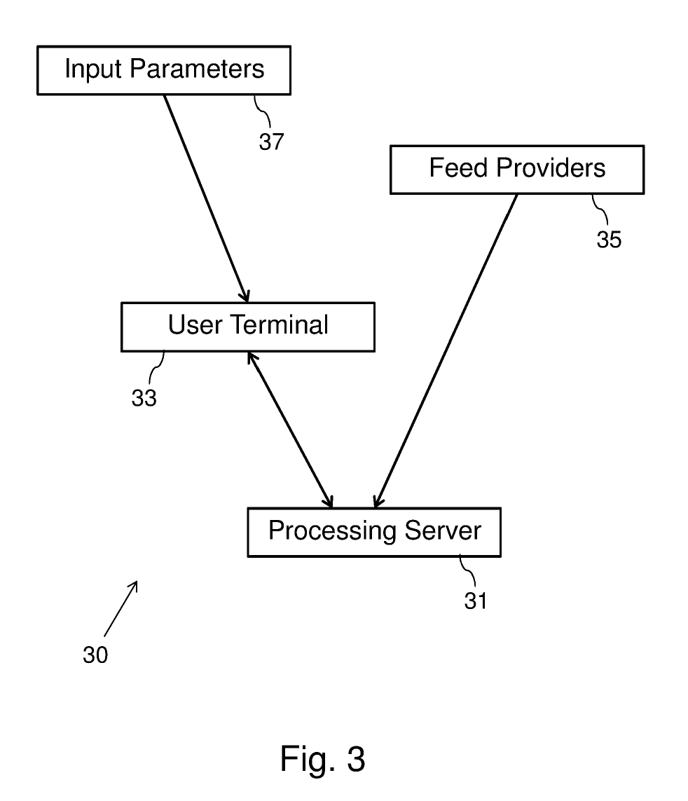

FIG. 3 schematically illustrates a training system 30 (wherein the directions of arrows indicates the direction of information flow). The training system 30 comprises a user terminal 33 for interaction with the user during the training process. The user terminal 33 may be implemented with at least one of the following:
Dedicated portable devices—having a built in general packet radio service (GPRS) connection (or any other wireless services) capable of sending and receiving information via existing cellular networks such that information may be received from feed providers 35. Such devices may have a graphical user interface (GUI) for interaction with the user (e.g. a touch screen). Optionally, such devices may further have a scanner capable of identifying markings on tickets or other elements (such as unique barcodes), a printer capable of printing output for the user, and a card reader capable of identifying information of “smart cards”.
Dedicated training machines—having a network connection capable of receiving information from feed providers 35. Such devices may have a GUI for interaction with the user, and additional features for the training process. For example, an additional scanner capable of identifying markings on tickets or other elements, and/or a printer capable of printing output for the user.
Existing “point of sale” devices, with a dedicated training algorithm—having existing infrastructure capable of allowing receiving information from feed providers 35. Such devices may have the dedicated training algorithm implemented onto the device such that these devices designed for other purpose may be utilized for the training.
Dedicated software implemented on existing mobile devices—having existing infrastructure capable of allowing receiving information from feed providers 35. Such devices (for instance smartphones or PCs) may provide an easy access for training as any user may implement a dedicated training algorithm on their private device and use the “virtual” training process at any time and/or place.

Each of the abovementioned devices comprises a processing server 31, onto which the training algorithm may be implemented. The processing server 31 continuously receives information from the feed providers 35, such that the training may be carried out with real-time information from real financial markets. The processing server 31 then processes the received information from the feed providers 35, and if any changes are required then corresponding data may be transferred to the user terminal 33. For example, a new trading day at the stock exchange may open new assets for selection at the user terminal 33.

When a user commences a new training session, the initial selections 21, 22 (as shown in FIG. 2) are transferred as input parameters 37 to the user terminal 33. For example, after a predetermined expiry period for certain assets chosen by the user as input parameters 37, the corresponding information relating to these assets (received from the feed providers 35) may be transferred from the processing server 31 to the user terminal 33.

Referring now to FIGS. 4A-4E, these figures show exemplary outputs for the abovementioned training. FIG. 4A shows an exemplary printed ticket prior to selections made by the user. FIG. 4B shows an exemplary printed output ticket with information on the selections of the user. FIG. 4C shows an exemplary printed confirmation output for a correct prediction, and FIG. 4D shows an exemplary printed confirmation output for an incorrect prediction. FIG. 4E shows an exemplary printed report for previous actions. It is appreciated that even in embodiments where the training process is implemented on virtual machines (with dedicated training algorithms), it is still possible to create the abovementioned printed tickets, for instance with household printers working with a dedicated training algorithm.

In a preferred embodiment, a user may use a user terminal (e.g. with a dedicated portable device) for the training process. An empty ticket may then be printed to be later filled by the user (for instance as shown in FIG. 4A). Such empty tickets may include a first section 41 with single or multiple expiry options, a second section 42 with several asset types, and optionally also a third section 43 with achievable prizes if the predicted outcome is correct.

If a user chooses and marks the multiple expiry options in the first section 41, then the selected assets go through multiple expiry periods. For example, a binary option training company allows a new training session (or a new game) every round hour starting from ten in the morning until eight in the evening, whereby expiry periods are predetermined to be fifteen minutes. Then a user may choose a quadruple expiry period, by marking a box marked “4” in the ticket. If that ticket, with predicted outcome, is submitted (for instance scanned by the dedicated portable device) at 6:50 in the evening, then the first training session commences at 7:00 in the evening as the first round hour since during the first fifteen minute expiry period a round hour occurred (otherwise the following round hour commences the session). Commencing of the training session means that real-time data is retrieved for the feed providers and compared to the predicted outcome to check if the prediction was correct. Unless stopped by the user, the same predicted outcome continues for additional expiry periods. The following training session is at 8:00 in the evening and then continued in the following day with two sessions at 10:00 and at 11:00 in the morning. It is appreciated that training sessions may also be chosen to be very short, for instance every five minutes.

It should be noted that the duration of an expiry period or of the time of commencing training sessions is determined by the company providing this service. Optionally, the users may determine by themselves the conditions of the expiry periods (for instance choosing an expiry period of twenty four hours).

Next, the user selects the desired assets in the second section 42 (as described for the training board in FIG. 1). It is appreciated that the user may select a multiple number of asset types (e.g. Currencies, Stocks, and Commodities), and further select a multiple number of assets for each asset type (e.g. for Commodities may choose Gold, Oil, and Silver). For example, a user may select Currencies and Commodities as the asset types, with the assets EUR/GBP, EUR/USD and OIL respectively.

In a further embodiment, the number of asset types may be predetermined. Additionally, the number of assets for each asset type may also be predetermined. Optionally, the types of asset and/or individual assets may also be predetermined by the user. For instance providing particular assets for regional markets (e.g. flower prices in countries with significant flower markets).

Once the assets have been selected, the user may mark for each asset a predicted outcome. Namely, mark for each asset whether the value increases or decreases at the end of the expiry period. It is appreciated that each asset may have two boxes 46 to be marked by the user, wherein a first box indicates that the predicted value increases and a second box indicates that the predicted value decreases. Optionally, the boxes 46 may be indicated with up and down arrows marking increase and decrease respectively (for instance as shown in FIG. 1).

In some embodiments, by marking one of the boxes 46 for a particular asset, the user also selects that asset for the predicted outcome. Thus, the user may simply mark one box 46 for at least one asset and thereby finish the selection for the desired assets and predicted outcome. With a single marking (of a box 46) both the assets and their predicted outcome are chosen. Optionally, tickets marked by the user may be scanned (e.g. by the dedicated portable device), whereby the markings by the user are converted to selection of assets by a dedicated training algorithm.

It should be noted that at the end of the expiry period, the predicted outcome for each selected asset is compared to real-time data from feed providers. Thus, the dedicated training algorithm checks whether the outcome predicted by the user (for the selected assets) is correct.

In a further embodiment, a user may use information provided in a third section 43 with achievable prizes if the predicted outcome is correct. If a box for multiple assets 44 is marked, then the user may achieve additional prizes if the prediction for multiple assets is correct. For example, if three predictions for outcome of assets are correct, then the user may achieve a particular prize based on predetermined odds. Optionally, the odds may be predetermined by the user or by the company providing the training sessions.

If a box for automatic selection 45 is marked, then the user may achieve additional prizes if the prediction for multiple assets is correct wherein each asset (chosen automatically) belongs to a different asset type. For example, if three predictions for outcome of assets are correct for three respective asset types, then the user may achieve a particular prize based on predetermined odds.

In a further embodiment, the user may achieve additional prizes if the prediction for consecutive multiple expiry periods is correct. For example, if three predictions for outcome of an asset (e.g. up-down-up for NASDAQ) are correct for three consecutive expiry periods, then the user may achieve a particular prize based on predetermined odds.

In a further embodiment, the asset types and/or the assets for each asset types in the second section 42, are displayed as general numbers (i.e. #1, #2, #3 etc.) instead of displaying the names of the assets. Thus, a generic ticket may be provided for all users with outcome for general numbers to be filled. If an external display (e.g. a TV screen or a billboard) shows a legend coupling between the general numbers and the assets that they represent, then a user may fill predicted outcome for real assets using a generic ticket with general numbers. It is appreciated, that if only general numbers are printed on the ticket with a legend on an external display, then it may be possible to change the assets when required (for instance if trading in Silver stops for that day unexpectedly). For example, a user marks an outcome up for #3, indicating that the chosen asset is EUR/US.

Once the ticket is filled by the user and submitted to be scanned and read by the training system (e.g. with a dedicated portable device), then an output ticket may be printed for the user (for instance as shown in FIG. 4B). Such output may include information on the selections of the user 48, a unique readable ID number (or barcode) 47, and possibly the time and date of the submission of the ticket.

If a predicted outcome is found to be correct, after comparison to real-time values at the end of the expiry period, then a winning ticket may be printed (for instance as shown in FIG. 4C). Such confirmation of a correct outcome may include information on the assets for which the predictions was correct 49, a unique readable ID number (or barcode) 47, and possibly a final confirmation number 51.

If all predicted outcomes are found to be incorrect, after comparison to real-time values at the end of the expiry period, then a confirmation output may be printed (for instance as shown in FIG. 4D). Such confirmation may include a message to try again 49, a unique readable ID number (or barcode) 47, and possibly a final confirmation number 51.

In a further embodiment, all possible choices for assets, asset types etc. are provided at a single ticket from, which the user may select the predicted outcome. For example, a ticket with twenty asset types, and a total of ninety possible assets.

In a further embodiment, the confirmation output may be printed on the same ticket on which the user makes the selections. Thus, unnecessary waste of paper may be prevented as the same ticket is used both as an empty form on which the user marks predicted outcome, and also as a final confirmation printout. In a further embodiment, the confirmation output may be provided at an individual user account that is created for the purpose of participating in the training.

It should be noted that while the abovementioned embodiments relate to training in the financial domain, same principals may apply for similar training in other domains. Therefore, the same training system and method may be utilized for almost any possible field. For example, using the abovementioned system for training to predict outcome of sport events, whereby some additional random factor may be added to the algorithm (e.g. due to coin flipping in some sport games). Similarly, the abovementioned embodiments may also apply to games or trading with financial assets.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A system for checking a prediction of non-random binary outcome, comprising:
a processing server, with a connection to at least one external feed provider having real-time data on the non-random binary outcome; and
a user terminal connected to the processing server, the connection allowing sending and receiving information, wherein the user terminal is also configured to allow sending input parameters to the processing server,
wherein the processing server has a dedicated binary prediction algorithm configured to allow comparison between the input parameters and data received from the at least one external feed provider, and wherein the input parameters correspond to prediction of the non-random binary increased or decreased outcome.

2. The system of claim 1, wherein the input parameters correspond to initial information received from the at least one external feed provider.

3. The system of claim 1, wherein the user terminal has a wireless service connection configured to allow receiving information from the at least one feed provider.

4. The system of claim 1, wherein the user terminal further has a graphical user interface (GUI) configured to allow interaction with the user to enter the input parameters.

5. The system of claim 1, wherein the user terminal further has a scanner capable of identifying markings on a physical card, and wherein the markings correspond to prediction of the non-random binary outcome.

6. The system of claim 1, wherein the user terminal further has a printer capable of printing output corresponding to the input parameters.

7. The system of claim 1, wherein the user terminal further has a card reader capable of identifying information from smart cards.

8. The system of claim 1, wherein the user terminal is selected from a group including: dedicated portable devices, dedicated training machines, pre-existing devices with a dedicated training algorithm.

9. The system of claim 1, wherein the comparison is carried out at a predetermined expiry period.

10. A device for checking a prediction of non-random binary outcome, comprising:
a graphical user interface (GUI) configured to allow interaction with the user; a wireless service connection, configured to allow receiving information from at least one feed provider having real-time data on the non-random binary outcome; and
a processor with a dedicated binary prediction algorithm, configured to allow comparison between a prediction for the non-random binary increased or decreased outcome and data received from the at least one external feed provider.

11. The device of claim 10, further comprising a scanner capable of identifying markings on a physical card, wherein the markings correspond to the prediction of the non-random binary outcome.

12. The device of claim 10, further comprising a printer capable of printing output corresponding to the prediction of the non-random binary outcome.

13. The device of claim 10, further comprising a card reader capable of identifying information from smart cards.

14. The device of claim 10, wherein the comparison is carried out at a predetermined expiry period.

15. A method for checking a prediction of non-random binary outcome, comprising:
displaying at least one asset;
choosing an expiry period;
selecting at least one asset from the displayed assets;
marking an increased value or a decreased value, for each of the selected at least one asset;
receiving real-time data from at least one feed provider at the end of the expiry period, wherein the data comprises information on change in value for the selected at least one asset;
comparing the received data with a predicted outcome form the marking; and
providing physical confirmation if at least one marking matches the received data.

16. The method of claim 12, wherein the method further comprises providing physical output, and wherein the output corresponds to the selections and markings.

17. The method of claim 12, wherein the method further comprises choosing a multiple expiry period, and wherein receiving real-time data and comparison to markings restarts for each chosen multiple expiry periods.

18. The method of claim 12, wherein the markings are carried out on a physical card, and wherein the method further comprises reading the markings from the physical card.
